(19) United States
(12) Patent Application Publication
(10) Pub. No.: US 2026/0107270 A1
(43) Pub. Date: Apr. 16, 2026

(54) SCHEDULING ENHANCEMENT FOR EXTENDED REALITY AND CLOUD GAMING SERVICES

(71) Applicant: GOOGLE LLC, Mountain View, CA (US)

(72) Inventors: Chih-Hsiang Wu, Taoyuan City (TW); Abdellatif Salah, Mountain View, CA (US); Kao-Peng Chou, Taoyuan City (TW)

(73) Assignee: GOOGLE LLC, Mountain View, CA (US)

(21) Appl. No.: 19/116,065

(22) PCT Filed: Oct. 2, 2023
(86) PCT No.: PCT/US2023/075763

§ 371 Date: Mar. 27, 2025

Related U.S. Application Data
(60) Provisional application No. 63/378,022, filed on Sep. 30, 2022.

(51) Int. Cl. H04W 72/115; H04W 72/02; H04W 72/21

(52) U.S. Cl. CPC H04W 72/115; H04W 72/02; H04W 72/21

(57) ABSTRACT

A transmission method implemented in a UE comprises generating an indication of a remaining delay budget for uplink (UL) data, transmitting, to a radio access network (RAN), the indication of the remaining delay budget, and transmitting the UL data to the RAN, via one or more UL resources allocated by the RAN.

### CROSS-REFERENCE TO RELATED APPLICATIONS

This application claims priority to and the benefit of the filing date of provisional U.S. patent application Ser. No. 63/378,022 entitled “SCHEDULING ENHANCEMENT FOR EXTENDED REALITY AND CLOUD GAMING SERVICES,”filed on Sep. 30, 2022. The entire contents of the provisional application are hereby expressly incorporated herein by reference.

### FIELD OF THE DISCLOSURE

This disclosure relates to wireless communications and, more particularly, to managing communications using enhanced scheduling mechanisms for services associated with low latency such and high data rate.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The 3rd Generation Partnership Project (3GPP) recently proposed that a 5G system (5GS) start providing support of advanced media services such as High Data Rate Low Latency (HDRLL) services, augmented reality (AR)/virtual reality (VR)/extended reality (XR) services, and tactile/multi-modality communication services, wireless cloud gaming, offline sharing of 3D objects, XR conferencing, etc. XR and media services also can be referred to as “XRM services.” Generally speaking, 3GPP proposed to study enhancements of network exposure to support interaction between 5GS and XRM applications

In XR, a video frame/slice arrives at once and uses multiple scheduled slots. A system uses multiple Transmit Blocks (TBs) to transmit the video frame/slice. The system maps multiple TBs to multiple physical downlink shared channels (PDSCHs) and physical uplink shared channels (PUSCHs). Using a single physical downlink control channel PDCCH to schedule a single PDSCH/PUSCH consumes a lot of control overhead and penalizes spectral efficiency. A single downlink control information (DCI) scheduling multi-PDSCHs (for downlink (DL)) or multi-PUSCHs (for uplink (UL)) reduces the control overhead and frees more resources for PDSCH/PUSCH transmission, thereby improving the overall system capacity.

A single DCI scheduling multi-PDSCHs or multi-PUSCHs improves system capacity for XR service. Further, this feature addresses the issue of large and varying packet sizes for the XR traffic. In particular, XR transmission uses large packet sizes and can reach up to 90 Kbytes. A typical packet uses multiple slots to be transmitted.

A single DCI scheduling multi-PUSCHs is supported for frequency range 1 (FR1) and frequency range 2 (FR2) (e.g., from 3GPP Rel-16, such as Rel-16 NR-U). However, past restrictions on the technology have included a system implementing all PUSCHs within consecutive slots.

Presently, a single DCI scheduling multi-PDSCHs is supported for FR2-2 for the following numerologies: 120 kHz, 480 kHz, and 960 kHz. In particular, supporting single DCI scheduling for FR2-2 reduces the UE blind decoding complexity for PDCCH in larger numerologies.

However, a single DCI scheduling multi-PDSCHs or multi-PUSCHs does not allow for fast hybrid automatic repeat request (HARQ-ACK) feedback, as the HARQ-ACK feedback is transmitted after the last PDSCH of the multiple PDSCHs. The scheme also lacks flexibility compared to a single DCI scheduling single PDSCHs/PUSCHs (e.g., physical resource block (PRB) allocation, modulation coding scheme (MCS), etc.).

Moreover, the code-block group (CBG) transmission scheme is an efficient scheduling mechanism that can improve spectral efficiency by retransmitting the failing CBGs only instead of transmitting a whole TB. The number of CBGs per TB is radio resource control (RRC) configured via various IEs, (e.g., maxCodeBlockGroupsPerTransportBlock). Configured Grant (CG) scheduling is similarly useful for UL AR traffic to reduce latency compared to dynamic grant (DG) scheduling. However, CG currently lacks flexibility to adjust the resources, as UL AR traffic has large but variable packet sizes.

### SUMMARY

The instant techniques provide benefits in addressing data services with strict latency and/or reliability requirements. In particular, because XR is a high data rates service that has stringent latency and reliability requirements, the use of techniques for utilizing CBGs as described herein to optimize retransmissions improves the system capacity while continuing to meet the requirements for XR traffic. As such, the instant techniques provide new scheduling mechanisms and enhancements to the existing scheduling mechanisms to enable the support of the XR service on 5G with good system capacity.

One example embodiment of these techniques is a a transmission method implemented in a user equipment (UE), the method comprising: generating an indication of a remaining delay budget for uplink (UL) data; transmitting, to a radio access network (RAN), the indication of the remaining delay budget; and transmitting the UL data to the RAN, via one or more UL resources allocated by the RAN.

Another example embodiment of these techniques is a method implemented in a UE for scheduling transmission of data packets to a RAN node and transmitting information regarding the data packets to the RAN node, the method comprising: scheduling, at the UE, a transmission for an uplink data packet to the RAN node; calculating, at the UE, a remaining delay budget indicative of a remaining quantity of time until the UE discards the uplink data packet; and transmitting, from the UE to the RAN node, an indication of the remaining delay budget.

Another example embodiment of these techniques is a method implemented in a UE for discarding sets of uplink packet data scheduled to be communicated with a RAN node, the method comprising: scheduling, at the UE, transmission to the RAN node of one or more uplink data packets of an uplink data packet set; detecting at least one of: (i) a limited delay budget indicative of a remaining quantity of time until the UE flushes a buffer for transmitting the one or more uplink data packets or (ii) congestion in the RAN; and discarding the uplink data packet set responsive to the detecting.

Another example embodiment of these techniques is a method implemented in a UE for requesting modification of uplink channel occasions from a RAN node, the method comprising: transmitting, from the UE to the RAN node, uplink control information including a first request for an adjustment of uplink resources; receiving, from the RAN node at the UE and responsive to the transmitting the uplink control information, an indication that the RAN node configures multiple uplink channel occasions; and responsive to receiving the indication, transmitting, from the UE to the RAN node, a second request to modify at least some of the multiple uplink channel occasions.

Another example embodiment of these techniques is a method implemented in a RAN node for modifying uplink channel occasions for a UE, the method comprising: receiving, from the UE at the RAN node, uplink control information including a first request for adjustment of uplink resources; responsive to receiving the uplink control information, configuring multiple uplink channel occasions for the UE; receiving, from the UE at the RAN node, a second request to modify at least some of the multiple uplink channel occasions; and responsive to the second request, modifying at least some of the multiple uplink channel occasions.

### DESCRIPTION OF THE DRAWINGS

FIG. 1A is a block diagram of an example system in which a radio access network (RAN) and a user device can implement the techniques of this disclosure for scheduling enhancements for extended reality and cloud gaming services.

FIG. 1B is a block diagram of an example base station including a centralized unit (CU) and a distributed unit (DU) that can operate in the system of FIG. 1A.

FIG. 2 is a block diagram of an example protocol stack according to which the UE of FIG. 1A communicates with base stations.

FIG. 3 shows an example of single DCI scheduling multiple PDSCHs in time division duplex (TDD) mode where the UE can stop monitoring PDCCH after the reception of the single DCI.

FIG. 4 shows an example of single DCI scheduling multiple PDSCHs with HARQ-ACK feedback transmitted after the last PDSCH of the multiple PDSCHs.

FIG. 5 shows an example of single DCI scheduling multiple PDSCHs with HARQ-ACK feedback transmitted after the each PDSCH of the multiple PDSCHs.

FIG. 6 shows an example of CBG-based transmission.

FIG. 7 shows an example of CBG-based transmission with capabilities for dynamic change of a number of CBGs per TB.

FIG. 8 shows an example of the quasi-periodic XR traffic with the variable packet size and with the arrival time impacted by the jitter.

FIG. 9 shows an example of CG-based transmission with a UE modem and application.

FIG. 10A shows an example scenario, implemented in a RAN node such as a gNB, for determining to switch to DG scheduling.

FIG. 10B shows an example scenario similar to FIG. 10A, but in which the RAN node determines to maintain CG scheduling.

### DETAILED DESCRIPTION

A user equipment (UE) and/or a base station of this disclosure support scheduling and transmission techniques to support the demands of XR services. In particular, XR has high data rates requirements and very low latency and high reliability requirements. Such stringent requirements, although used to provide good user quality of experience (QoE), limit the system capacity, which makes the service less attractive for deployment. Scheduling enhancements are needed to allow for a larger number of UEs to utilize the service simultaneously. Scheduling enhancements can include not only new scheduling techniques, but also enhancements to the existing techniques. Enhancements, to be efficient, should take into consideration the specificities of the XR traffic (periodicities, packets sizes, jitter, etc.).

Because XR is a high data rates service and has stringent latency and reliability requirements, the use of CBGs to optimize retransmissions is useful to improve the system capacity and meet the stringent requirements.

New scheduling mechanisms and enhancements to the existing scheduling mechanisms are needed to enable the support of the XR service on 5G with good system capacity.

The code-block group (CBG) transmission scheme is an efficient scheduling mechanism that can improve spectral efficiency by retransmitting the failing CBGs only instead of transmitting a whole TB. The number of CBGs per TB is radio resource control (RRC) configured via various IEs, (e.g., maxCodeBlockGroupsPerTransportBlock).

Configured Grant (CG) scheduling is similarly useful for UL AR traffic to reduce latency compared to dynamic grant (DG) scheduling. However, CG currently lacks flexibility to adjust the resources, as UL AR traffic has large but variable packet sizes.

Depending on the implementation, multiple enhancements can improve the scheduling of XR services: (i) extending the single DCI scheduling multi-PDSCHs to FR2 and/or FR1 and introducing further enhancements to better support the XR traffic; (ii) enhancement to the single DCI scheduling multi-PUSCHs to better support the XR traffic; (iii) enhancement to the CBG transmission scheme; and/or (iv) Configured Grant enhancement.

A single DCI scheduling multi-PDSCHs or multi-PUSCHs is to be activated separately for frequency division duplex (FDD) and TDD modes. In some implementations, the activation and the deactivation of the single DCI scheduling multi-PDSCHs or multi-PUSCHs is signalled or configured separately for FDD and TDD modes. In further implementations, a single DCI scheduling multi-PDSCHs or multi-PUSCHs are supported for TDD mode only.

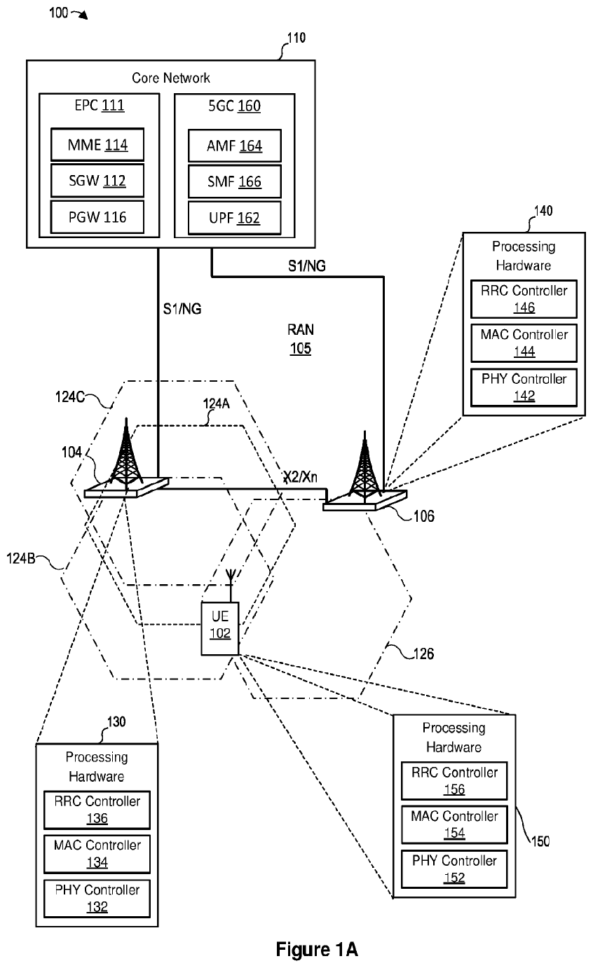

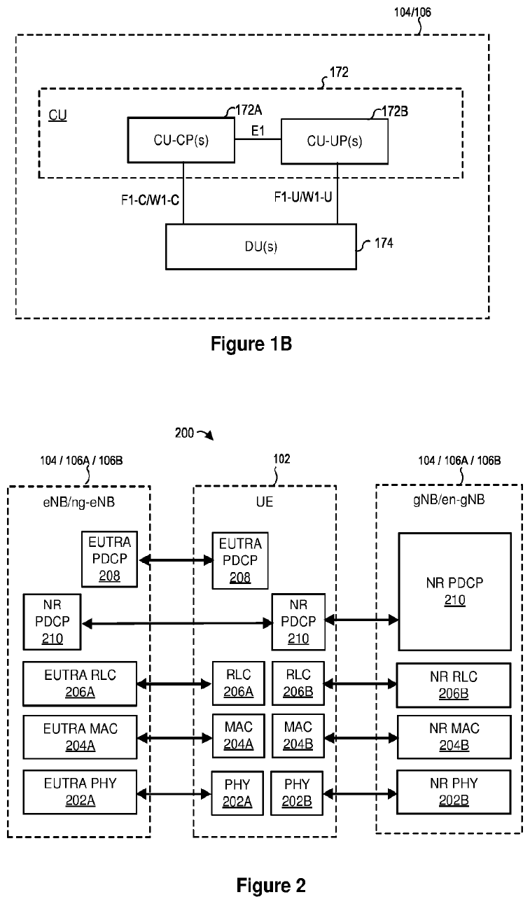

FIG. 1A depicts an example wireless communication system 100 in which communication devices can implement these techniques. The wireless communication system 100 includes a UE 102, a base station (BS) 104, a base station 106 and a core network (CN) 110. The CN 110 can be implemented as an evolved packet core (EPC) 111 or a fifth generation (5G) core (5GC) 160, for example. The CN 110 can also be implemented as a sixth generation (6G) core, in another example.

A core network (CN) 110 can be an evolved packet core (EPC) 111 or a fifth-generation core (5GC) 160, both of which are depicted in FIG. 1A. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. The DU 174 is also equipped with processing hardware that can include one or more general-purpose processors such as CPUs and non-transitory computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware may further include a physical layer controller configured to manage or control one or more physical layer operations or procedures.

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

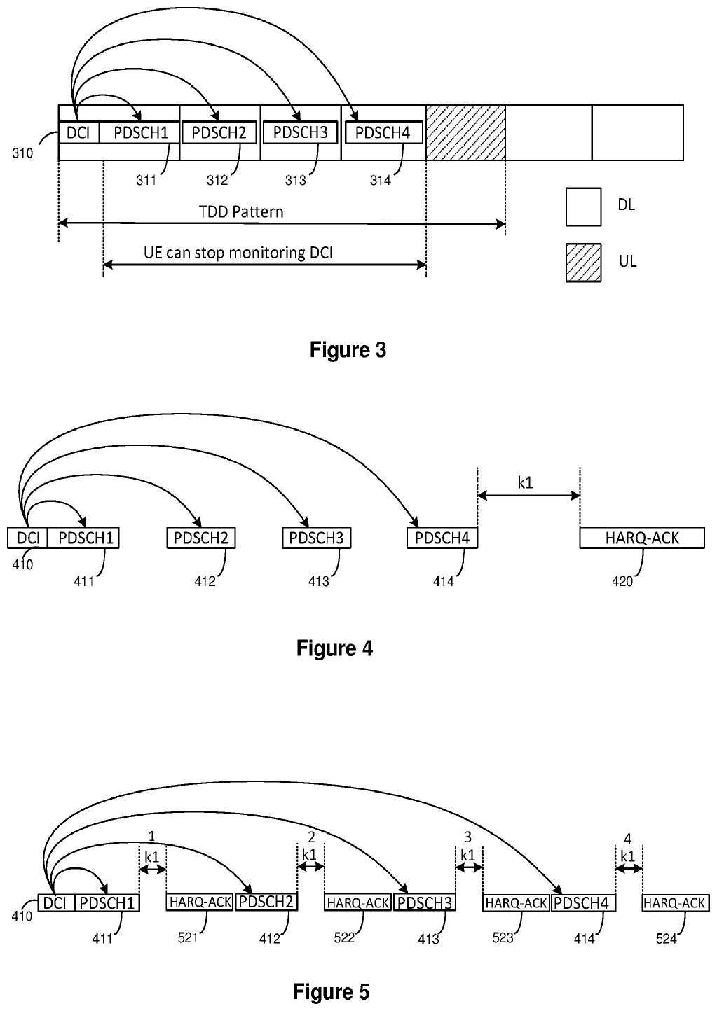

FIG. 3 shows an example of a single DCI 310 scheduling multiple PDSCHs 311, 312, 313, and 314 in TDD mode where the UE, in some implementations, stops monitoring PDCCH after the reception of the single DCI 310 until the DL slot following the next UL slot, thereby saving PDCCH monitoring power without impacting the system performance. In particular, the UE does not report HARQ-ACK feedback until the next UL slot, and therefore the next generation NodeB (gNB) (e.g., a base station 104 and/or other RAN node of RAN 105) does not schedule any retransmissions in the meantime.

In some implementations, dedicated RRC configurations are used to activate and deactivate the single DCI scheduling multi-PDSCHs or multi-PUSCHs. In further implementations, dedicated DCI formats are specified and used for scheduling multi-PDSCHs or multi-PUSCHs. Depending on the implementation, existing DCI format 0_1 and DCI format 1_1 or existing compact DCI format 0_2 and DCI format 1_2 are reused for scheduling multi-PDSCHs or multi-PUSCHs in FR1 and/or FR2.

In some implementations, a single DCI scheduling multi-PDSCHs or multi-PUSCHs in FR1 and/or FR2 is enabled implicitly (e.g., for the XR service). In further implementations, a single DCI scheduling multi-PDSCHs or multi-PUSCHs is used to schedule one or more PDU sets and/or one or more Data Bursts.

In some implementations, supporting a single DCI scheduling multi-PDSCHs or multi-PUSCHs in FR1 and/or FR2 is defined as a UE capability. In further implementations, the UE reports to the gNB if the UE supports such a feature in FR1 and/or FR2.

A single DCI scheduling multi-PDSCHs supported in FR2-2 suffers from latency issues, as, in some such implementations, the HARQ-ACK feedback is transmitted after the last PDSCH of the multi-PDSCHs transmission. Hence, the gNB does not schedule any retransmissions for any failing PDSCH until the HARQ-ACK feedback is received after the end of the bulk transmission of PDSCHs.

FIG. 4 shows an example design of a single DCI 410 scheduling multiple PDSCHs 411, 412, 413, and 414 for FR2-2. The HARQ-ACK feedback 420 for all the PDSCHs is transmitted in kl slots after the end of the last PDSCH of the group of PDSCHs scheduled by the single DCI. For XR traffic, receiving the HARQ-ACK feedback as soon as possible (e.g., as described in FIGS. 3 and 5) improves the ability of a system to schedule the retransmissions before the expiry of the small packet delay budget (e.g., for XR and cloud gaming).

FIG. 5 shows an example of a single DCI 410 scheduling multiple PDSCHs 411, 412, 413, and 414. Physical uplink control channel (PUCCH) resources for HARQ-ACK feedback 521, 522, 523, and 524 are respectively configured for PDSCHs with different or the same k1 values that apply to each PDSCH.

In some implementations, dl-DataToUL-ACK is an RRC parameter and is the set of configured offsets between the downlink slot carrying PDSCH and the uplink slot where the HARQ-ACK feedback for the PDSCH is to be transmitted. In some implementations, eight values are configured from a range of 0 to 15. A bit-field timing indicator (e.g., a PDSCH-to-HARQ_feedback timing indicator) to signal k1 in DCI format 1_1 signals the value of k1. Depending on the implementation, the timing indicator (e.g., the PDSCH-to-HARQ_feedback timing indicator) is 0, 1, 2, or 3 bits. The bitwidth for the field is determined as ┌log₂(I)┐ bits, where I is the number of entries in the higher layer parameter dl-DataToUL-ACK.

As illustrated in the example of FIG. 5, in some implementations, the timing indicator signals ak1 per PDSCH in the DCI, which increases the DCI overhead. For example, if 8PDSCHs are scheduled by a single DCI and 3 bits are used for the signalling of the timing indicator (e.g., the PDSCH-to-HARQ_feedback timing indicator), then 8×3=24 bits are needed to signal all k1 values.

In some implementations, to reduce the signalling overhead for the signalling of the timing indicators (e.g., the PDSCH-to-HARQ_feedback timing indicators) for all PDSCHs, the timing indicators signal a single k1 value, which is applied to all PDSCHs. As such, HARQ-ACK feedback is transmitted for each PDSCH in a PUCCH located k1 slot after the end of each PDSCH. In further implementations, to reduce the signalling overhead, the timing indicators signal the first k1 for the first PDSCH, and the timing indicators signals the remaining k1 values for the remaining PDSCHs as a delta value with respect to the first k1. For example, the first k1 for the first PDSCH is encoded in 3 bits, and each of the remaining k1 values are encoded in n bits where n=1 or n=2. Hence, for example, if 8 PDSCHs are scheduled by a single DCI and 3 bits are used for the signalling of the timing indicators PDSCH-to-HARQ_feedback timing indicator, and n=1, then 3+7×n=10 bits are used to signal the set of k1 for all the PDSCHs. In further implementations, another RRC parameter (e.g., dl-ReferenceACK-ToUL-ACK) is configured for the set of delta values signalled by the n bits (e.g., if n =2, dl-ReferenceACK-ToUL-ACK will be of size=4).

In some implementations, to reduce the signalling overhead for the signalling of all the timing indicators (e.g., the PDSCH-to-HARQ_feedback timing indicators) for all PDSCHs, the timing indicators signal a k1 value to each sub-group of PDSCHs. For example, in some implementations, if 8 PDSCHs are scheduled by a single DCI, the timing indicators signal a first k1 value for the first sub-group of 4 PDSCHs and another k1 value for the second sub-group of 4 PDSCHs. In some implementations, sizes of the PDSCH sub-groups are semi-statically configured (e.g., via RRC) or dynamically signalled (e.g., via new or existing DCI bit-field). Further, in some implementations, such enhancement to the single DCI scheduling multi-PDSCHs scheduling scheme addresses HARQ-ACK feedback latency (e.g., the HARQ_feedback indicators).

The DCI bit-field PUCCH resource indicator (PRI) indicates the PUCCH resource(s) for PUCCH transmission in a slot. The PUCCH resource indicator field values map to values of a set of PUCCH resource indexes (e.g., as defined in Table 9.2.3-2 in TS 38.213). The DCI maps to PUCCH resources from a set of PUCCH resources provided by a table (e.g., the RRC configured table PUCCH-ResourceSet) with an example maximum of 8 PUCCH resources.

In some implementations, for a single DCI scheduling multiple PDSCHs, the DCI signals PRI per PDSCH or for sub-groups of PDSCHs. For example, if 8 PDSCHs are being scheduled by a single DCI, the DCI signals a PRI bit-field for the first sub-group of 4 PDSCHs and another PRI bit-field for the second sub-group of 4 PDSCHs.

In some implementations, the DCI signals an MCS per PDSCH. In some such implementations, signalling an MCS per PDSCH increases the DCI overhead. For example, if 8 PDSCHs are scheduled by a single DCI and 5 bits are used for the signalling of MCS (MCS table of size 32), then 8×5=40 bits are needed to signal all MCS values.

To reduce the signalling overhead for the signalling of all MCS values for all PDSCHs, the DCI signals the first MCS for the first PDSCH and the remaining MCS values for the remaining PDSCHs as a delta value with respect to the first MCS. For example the first MCS for the first PDSCH may be encoded in 5 bits and each of the remaining MCS values are encoded in n bits where n =1,n=2, n=3, or n=4. Hence, for example, if 8 PDSCHs are scheduled by a single DCI and 5 bits are used for the signalling of MCS and n=2, then 5+7×n=19 bits are used to signal the set of MCSs for all the PDSCHs.

In further implementations, to reduce the signalling overhead for the signalling of all the MCSs for all PDSCHs, the DCI signals an MCS value to each sub-group of PDSCHs. For example, if 8 PDSCHs are scheduled by a single DCI, the DCI signals a first MCS value for the first sub-group of 4 PDSCHs and another MCS value for the second sub-group of 4 PDSCHs. In some such implementations, the sizes of the PDSCH sub-groups are semi-statically configured (e.g., via RRC) or dynamically signalled (e.g., via new or existing DCI bit-field).

In some implementations, a single DCI scheduling multi-PDSCHs or multi-PUSCHs has reduced frequency resource allocation flexibility as the same PRB allocation is applied to all PDSCHs/PUSCHs. In further implementations, to relax such a constraint, frequency domain resource assignment (FDRA) is signalled per PDSCH/PUSCH in the DCI, which increases the DCI overhead. In some implemenations, to limit the overhead, the gNB (or another such RAN node) limits the number of PDSCHs/PUSCHs that can be scheduled with the same DCI and with different FDRA (e.g., maximum number of PDSCHs/PUSCHs=3). In some such implementations, two or more values for a maximum number of PDSCHs/PUSCHs scheduled by a single DCI are specified. In further such implementations, the maximum number of PDSCHs/PUSCHs scheduled by a single DCI is adjusted according to some specific configurations or signalling by the network. As an example, the maximum number of PDSCHs/PUSCHs scheduled by a single DCI is equal to 8 as a default value and is equal to 3 if FDRA is signalled per PDSCH/PUSCH in the DCI.

The use of CBGs for XR traffic improves the system efficiency and increases the system capacity. An enhancement to CBG-based transmission (e.g., a CBG transmission scheme enhancement) can be specified (e.g., for XR).

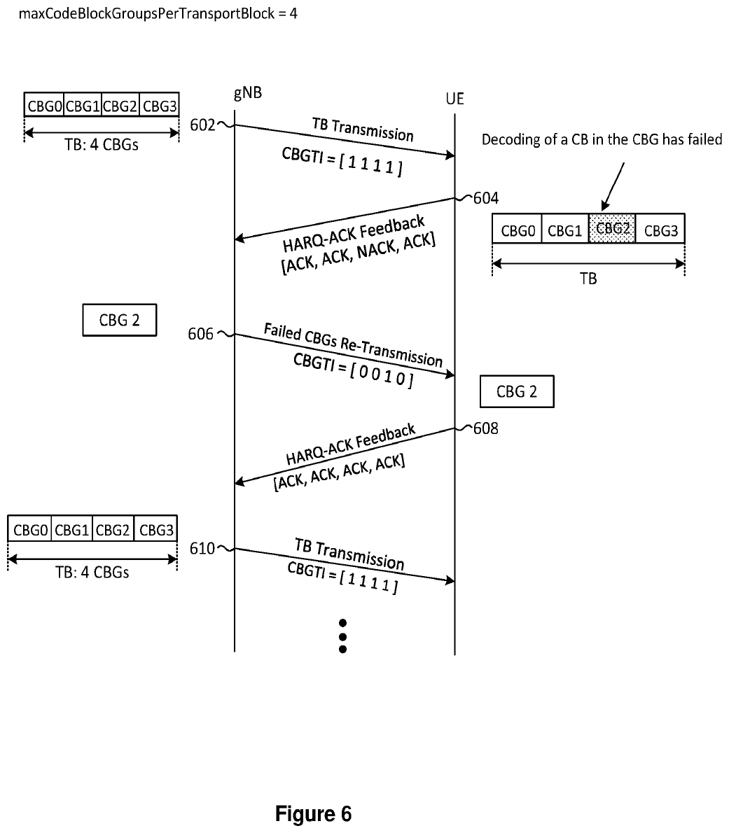

In some implementations, the maximum number of CBGs per TB is RRC-configured (maxCodeBlockGroupsPerTransportBlock), and the specified values are {2, 4, 6, 8}. FIG. 6 shows an example of the CBG-based transmission where a TB comprising 4 CBGs as configured in the maxCodeBlockGroupsPerTransportBlock parameter is transmitted 602.

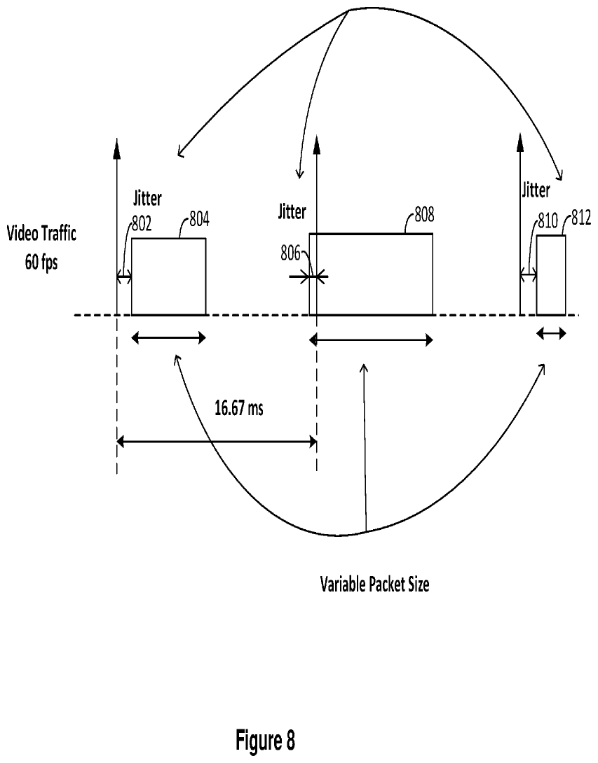

In the example embodiment of FIG. 6, one of the code blocks (CBs) in CBG 2 fails the decoding, and CBG 2 is to be retransmitted. The UE reports 604 the HARQ-ACK feedback with a number of bits equal to the number of the CBGs, and the gNB retransmits the failed CBG instead of retransmitting the entire TB (e.g., when the CBG-based transmission is not enabled). Since XR traffic in some implementations has different flows with video traffic (large packets), audio traffic (small packets), and pose/control information (small packets), the UE and/or RAN use a flexible number of CBGs per TB. Further, in some implementations, a system benefits from using a flexible number of CBGs per TB for mixed traffic (e.g., XR traffic and eMBB traffic) and/or for addressing variable packet sizes for XR traffic (e.g., large I-slices vs. smaller P-slices), as shown in FIG. 8. After receiving 608 further HARQ-ACK feedback, the gNB transmits 610 a different or the same TB transmission.

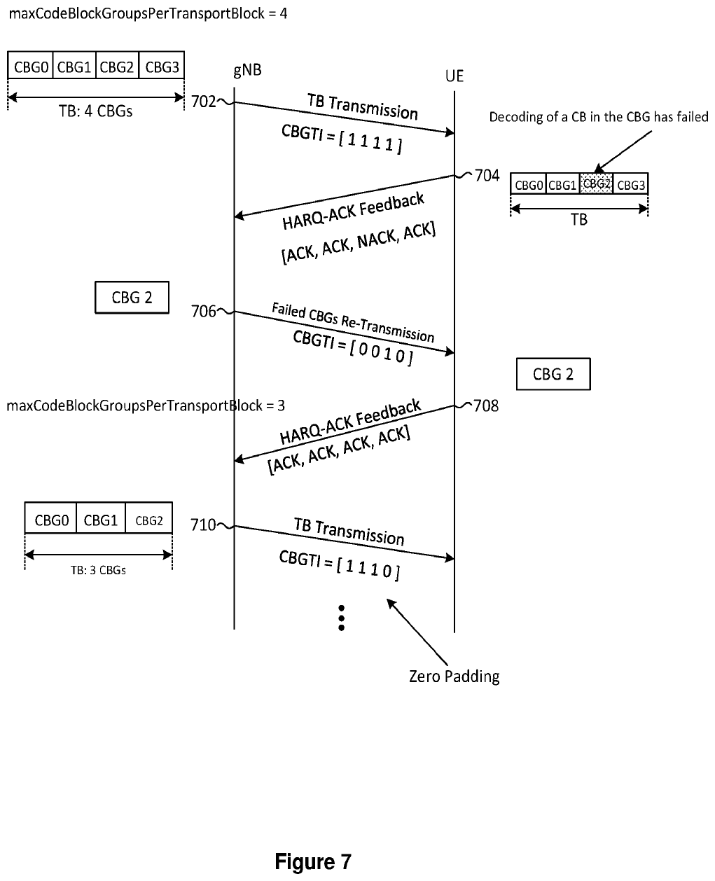

FIG. 7 illustrates an example of the CBG-based transmission similar to FIG. 6, but with a dynamic number of CBGs per TB rather than the maximum. Depending on the implementation, events 702, 704, 706, and/or 708 are performed similarly to events 602, 604, 606, and/or 608 of FIG. 6. As illustrated in FIG. 7, in some implementations, the number of CBGs per TB is signalled dynamically (e.g., L1 signalled) and/or a new or an existing DCI bit-field is used to signal the number of CBGs per TB. In some such implementations, such dynamic signalling (e.g., L1 signalling) and/or DCI bit-field techniques improve the flexibility of the system (e.g., for XR traffic) as described herein. In further implementations, the CBG transmission scheme is enabled and/or disabled dynamically. For example, in some such implementations the CBG transmission scheme is enabled per traffic flow or enabled depending on the TB size, as described in more detail below.

In some implementations, the UE is configured (e.g., via RRC signalling) with a range of numbers (e.g., {2, 4, 6, 8, 10, . . . }), and the DCI bit-field signals an index to one of the numbers. In further implementations, the gNB then transmits 710 the same or different TB transmission according to the dynamically determined number of CBGs.

In some implementations, control block group transmission information (CBGTI) is a DCI bit-field. A bit set to 1 in the CBGTI indicates that the corresponding CBG is present. A bit set to 0 in the CBGTI indicates that the corresponding CBG is not present. In some such implementations, by including a variable number of CBGs per TB, the CBGTI continues changing, which impact the DCI size. In further implementations, the CBGTI bit-field size is fixed to the maximum number in the configured range of numbers of possible CBGs per TB. As illustrated in FIG. 5, in some implementations, zero padding is used to pad the CBGTI field with zeros if the number of used CBGs is smaller than the maximum number.

In some implementations, the maximum number of CBGs per TB is configured (e.g., via RRC) depending on the TB size. For example, one or more TB size thresholds are specified or configured, and, if the TB size is smaller/larger than a specific TB size threshold, then a number of CBGs per TB is used.

In another implementation, multiple maximum numbers of CBGs per TB are specified and/or configured for the UE (e.g., via RRC), and the maximum to be used is selected by the gNB and/or UE according to some defined criteria.

In some implementations, the CBG transmission scheme is enabled and/or disabled dynamically (e.g., with a new or an existing DCI bit-field). In further implementations, the CBG transmission scheme is enabled per traffic flow (e.g., enabled for video traffic and disabled for audio traffic). In further implementations, the CBG transmission scheme is enabled for some PDU sets (e.g., PDU sets with high priority) and disabled for some other PDU sets (e.g., PDU sets with lower priority). In still further implementations, the CBG transmission scheme is enabled depending on the TB size. In some such implementations, a TB size threshold is specified or semi-statically configured (e.g., via RRC). In some implementations, if the TB size is larger than the threshold, then the CBG transmission scheme is enabled. In such implementations, if the TB size is smaller than the threshold, then the CBG transmission scheme is disabled. In further implementations, some or all of the above techniques are considered jointly (e.g., TB size and priority level (PDU set priority, packet priority, etc.)).

In an example implementation of FIG. 6, the CBG transmission scheme is not supported if the single DCI scheduling multi-PUSCHs or multi-PDSCHs is enabled. Both schemes allow for the XR traffic to improve the spectral efficiency of both control and data. In some implementations, a new RRC parameter is defined to enable and/or disable CBG transmission when a single DCI scheduling multi-PUSCHs or multi-PDSCHs is enabled.

In some implementations, a CBG transmission scheme enabled with the single DCI scheduling multi-PUSCHs or multi-PDSCHs increases the DCI size and increases the HARQ-ACK feedback overhead. For example, when a maximum of 8 CBGs per TB and a maximum of 8 TBs are scheduled by a single DCI, the size of the CBGTI is 8×8=64 bits, which leads to high levels of DCI overhead.

In some implementations, to reduce the DCI overhead of simultaneously enabling a CBG transmission scheme and the single DCI scheduling multi-PUSCHs or multi-PDSCHs, a restriction is defined on the Number of CBGs×Number of multi-PDSCHs. For example, the restriction is that the Number of CBGs×Number of multi-PDSCHs/PUSCHs≤N, where Nis equal to 32, 16, 8, etc. In further such implementations, N is a specified value, semi-statically configured value (e.g., via RRC), a dynamically signalled value (e.g., via DCI), or a UE capability reported value (e.g., a UE reports the N values the UE is able to support, and a gNB configures the UE with one of the reported values). In an exemplary embodiment of FIG. 6, the maximum number of CBGs per TB is configured via RRC. Also, in an exemplary embodiment of FIG. 6, the maximum number of multi-PDSCHs/PUSCHs is configured via RRC, and the CBG transmission scheme is not configured simultaneously with the multi-PDSCHs/PUSCHs scheme. In an exemplary embodiment of FIG. 7, the two features are allowed to be enabled simultaneously with flexibility on the number of CBGs and the number of PDSCHs/PUSCHs. However, a new signalled maximum is configured. As is detailed above, the new signalled maximum reflects the limit on the maximum number of CBGs multiplied by the number of multi-PDSCHs/PUSCHs.

FIG. 8 shows an example of the XR traffic shape. As shown in FIG. 8, XR traffic may be quasi-periodic traffic with a period equal to the inverse of the XR frame rate. Hence, if the frame rate is 60 frames per second (fps), the periodicity is 16.67 milliseconds (ms). The XR traffic in some implementations suffers from jitter (e.g., 802, 806, 810) (e.g., due to the delay variations at the codec to encode the video frames). In the example of FIG. 8, the jitter is able to be statistically modelled as a truncated Gaussian distribution with 2 ms standard deviation and +/−4 ms range. The XR packet sizes (e.g., frame sizes) are also large and variable due to the variability in the video frame content (e.g., I-frames, P-frames, B-frames), and, in some implementations, are also statistically modelled as a truncated Gaussian distribution. For example, in the exemplary embodiment of FIG. 8, a mean frame size is an average data rate, divided by an fps value for the video stream, divided by 8 bytes. Further, in some such implementations, the STD, max, and min values of the mean are 10.5%, 150%, and 50%, respectively, of the mean. For example, given a data rate of 30 Mbps and an fps of 60 fps, then mean is 64 kilobytes. In some implementations, for the UL direction, the pose/control information is modelled as periodic (e.g., 4 ms periodicity used in RAN 1) with fixed packet size (e.g., 100 bytes used in RAN 1) and with no jitter. For UL XR traffic (e.g., UL AR traffic), the traffic is modelled with no jitter values (e.g., in RAN 1), as the jitter for UL traffic is smaller than for DL traffic.

It will be understood that such values and modelling are exemplary only for the sake of readability and illustration, and that additional alternate values can similarly apply.

CG allows for UL AR scheduling to reduce UL latency compared to dynamic grant (DG). In DG, a UE sends an SR and then receives an UL grant to send a buffer status report (BSR) and transmit PUSCH. For CG, the SR and UL grant are not used, and the UE uses CG resources straight away for the transmission.

As such, in some implementations, a UE uses CG scheduling for UL pose and/or control (e.g., pose/control) information. For example, for UL pose/control information that arrives periodically (e.g., in a 4 ms period) with no jitter, and with a fixed packet size (e.g., 100-byte packets), a UE, in some implementations, uses CG type-1 or CG type-2 scheduling with no enhancement to support and/or transmit the UL pose/control information traffic.

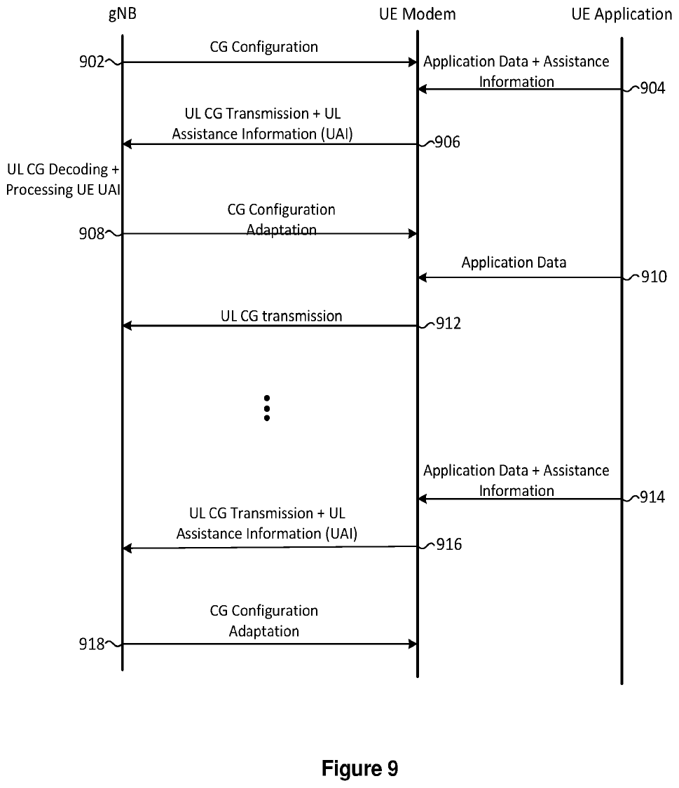

FIG. 9 illustrates an example of CG-based transmission. In some implementations, since UL XR (e.g., UL AR) packet sizes are large and variable, CG resources are not scaled for the largest packet size. In some implementations, configuring CG resources for the largest packet size is resource inefficient and penalizes system capacity. In other implementations, jitter (e.g., small quantities of jitter, large quantities of jitter, etc.) also impacts performance of CG (e.g., for CG-based transmissions). In some such implementations, configuring multiple PUSCH occasions addresses such variability of packet size. As such, in some implementations, a UE uses multiple PUSCH occasions in a CG period for UL traffic (e.g., UL AR traffic).

In some implementations, CG is enhanced by the UE providing assistance information (e.g., number of PDU sets, number of PDUs per PDU set, remaining delay budget or deadline per PDU set (or, additionally or alternatively, the arrival time per PDU set), priority per PDU set, data burst granularity, PDU set granularity, etc.), and the gNB adapts the CG configuration based on the UE assistance information. In further implementations, the gNB adapts the CG configuration based on the CG decoding status at the gNB side, as shown in FIG. 9. The gNB transmits 902 the CG configuration to a UE modem (e.g., of the UE 102 as described above with regard to FIG. 1).

In some implementations, the UE has awareness about the UL data and requests an increase or decrease of the CG resources. In further implementations, the UE sends a request via Uplink Control Information (UCI), e.g., piggy-backed on PUSCH or via MAC CE for adjustment of the UL allocated resources (e.g., UL allocated PUSCH resources). In still further implementations, the UE sends explicit information about the size of data in the buffer, number of PDUs, number of data bursts, and/or size of the current PDU or PDU set (e.g., waiting to be transmitted together with information about priority level or remaining delay budget, as described herein). In some implementations, at least some of the explicit information is sent via BSR. In some implementations, the UE sends the information together with information about the priority level and/or the remaining delay budget. In further implementations, the gNB uses the information to adjust CG resources and the CG configuration. For example, for a high priority PDU set with a small remaining delay budget, the gNB advances the CG PUSCH occasions and/or the CG resources, allocates larger time/frequency resources, and/or reduces MCS to ensure reliability. In some implementations, the gNB also decides to cancel PUSCH occasions and/or resources, such as for small PDU sets or low priority PDU sets with limited remaining delay budget (e.g., if the PDU sets are unlikely to be received and relayed on time)). In some implementations, if multiple PUSCH occasions per CG cycle are configured by the gNB, the UE requests to cancel some occasions (e.g., PUSCH occasions), add some occasions (e.g., PUSCH occasions), and/or modify some occasions (e.g., PUSCH occasions) in time and/or frequency by shifting or changing the size of the resources.

In further implementations, the UE sends information about the priority of the data to be transmitted. In some such implementations, the priority is at the PDU set level, at the PDU level, and/or at the data burst level. Ian further implementations, the UE signals the priority of the data in the buffer via UCI (e.g., on PUSCH) or via MAC CE. Depending on the implementation, the UE application transmits 904 such application data to the UE modem before the UE modem of the UE transmits 906 a UL CG transmission to the gNB.

In some implementations, the UE also transmits 904, 906 application-related assistance information, like the data rate of UL traffic (e.g., UL XR traffic), the frames per second (fps) of the UL traffic, or an arrival time of the UL traffic. In some implementations, the gNB uses this assistance information to adjust a CG configuration (periodicity, resources, etc.) and a C-DRX configuration (periodicity, on-duration, inactivity timer, etc.). In some implementations, UL XR (e.g., UL AR) traffic periodicities are not supported by current CG techniques. As such, in some implementations, the UE and/or gNB enhances CG periodicities as described herein to align with non-integer traffic periodicities (e.g., non-integer XR traffic periodicities). As such, in some implementations, CG resources are configured to align with the periodicities of the UL XR (e.g., UL AR) traffic. Depending on the implementation, the information is sent or updated by the UE dynamically via UCI (e.g., on PUSCH), via MAC CE, or via an RRC message (e.g., UEAssistanceInformation message).

For example, the UE transmits 906 first assistance information, including parameters such as a data rate for UL traffic, an fps of the UL traffic, and an arrival time of the UL traffic, to the gNB. In some implementations, the gNB transmits a first RRC reconfiguration message (e.g., RRCReconfiguration message) including a first CG configuration (e.g., ConfiguredGrantConfig) and/or a first C-DRX configuration (e.g., DRX-Config) to the UE based on the first assistance information. In response, the UE applies the first CG configuration and/or first C-DRX configuration and transmits a first RRC reconfiguration complete message (e.g., RRCReconfigurationComplete message) to the gNB. In some implementations, the first CG configuration configures a first set of CG resources and/or a first periodicity of the first CG resources based on the first assistance information. In other implementations, the gNB transmits (e.g., at event 902/908), to the UE, a DCI including a first CG configuration to configure the first CG resources. For example, the gNB configures the first periodicity based on the arrival time of the UL traffic. In another example, the gNB configures the first CG resources based on the fps and/or data rate. When the UE receives the first CG configuration, the UE transmits 910, 912, to the gNB, UL traffic packets on the first CG resources in accordance with the first CG configuration. The gNB receives, from the UE, the UL traffic packets on the first CG resources in accordance with the first CG configuration. In some implementations, when the gNB transmits the first C-DRX configuration to the UE (e.g., at event 902, 908), the gNB transmits, to the UE, DL traffic packets and/or DL control signals (e.g., reference signal(s) and/or DCIs), in accordance with the first C-DRX configuration. The UE receives, from the gNB, DL traffic packets and/or DL control signals in accordance with the first C-DRX configuration.

In some implementations, when the UE detects change(s) in one, some, or all of the parameters in the first assistance information, the UE transmits 914, 916, to the gNB, second assistance information including new value(s) of the parameter(s) that are changed. In some implementations, the gNB transmits 918 a second RRC reconfiguration message (e.g., RRCReconfiguration message), including a second CG configuration (e.g., ConfiguredGrantConfig) and/or a second C-DRX configuration (e.g., DRX-Config), to the UE based on the second assistance information. In response, the UE applies the second CG configuration and/or second C-DRX configuration, and transmits a second RRC reconfiguration complete message (e.g., RRCReconfigurationComplete message) to the gNB. In some implementations, the second CG configuration configures second CG resources and/or a second periodicity of the second CG resources based on the second assistance information. In some other implementations, the second CG configuration configures a second periodicity of the first CG resources, based on the second assistance information. In other implementations, the gNB transmits, to the UE, a DCI including a second CG configuration to configure the first CG resources. For example, the gNB configures the second periodicity based on the arrival time of the UL traffic. In another example, the gNB configures the second CG resources based on the fps and/or data rate. In some implementations, when the gNB transmits the second C-DRX configuration to the UE, the gNB transmits, to the UE, DL traffic packets and/or DL control signals (e.g., reference signal(s) and/or DCIs), in accordance with the second C-DRX configuration instead of the first C-DRX configuration. The UE receives, from the gNB, DL traffic packets and/or DL control signals in accordance with the second C-DRX configuration instead of the first C-DRX configuration.

In some implementations, the second CG configuration updates (e.g., augments or replaces) the first CG configuration. Thus, the UE updates the first CG configuration with the second CG configuration. In further implementations, the UE also transmits, to the gNB, UL traffic packets in accordance with the second CG configuration and configuration parameters included the first CG configuration and not changed by the second CG configuration, if any. The gNB receives, from the UE, the UL traffic packets with the second CG configuration and configuration parameters included in the first CG configuration and not changed by the second CG configuration, if any. In other implementations, the second CG configuration provides additional CG resources in addition to the first CG configuration. Thus, in some such implementations, the UE transmits, to the gNB, UL traffic packets on the first CG resources and second CG resources in accordance with the first CG configuration and second CG configuration, respectively. The gNB receives, from the UE, the UL traffic packets on the first CG resources and second CG resources in accordance with the first CG configuration and second CG configuration, respectively.

In some implementations, the first CG configuration includes one or more of: time domain resource allocation, frequency domain resource allocation, modulation and coding scheme, and/or transport block size. In some implementations, the second CG configuration includes one or more of: time domain resource allocation, frequency domain resource allocation, modulation and coding scheme, and/or transport block size. The first CG configuration is different from the second CG configuration.

In some implementations, the gNB enables or disables a function of transmission of the assistance information for UL traffic (e.g., XR traffic) for the UE. In some implementations, the gNB transmits, to the UE, an RRC message (e.g., an RRCReconfiguration message), including a configuration enabling the function of transmission of the assistance information for UL traffic. In response, the UE enables the function of transmission of assistance information for UL traffic and, in some implementations, transmits a first RRC response message (e.g., an RRCReconfigurationComplete message) to the gNB. In some implementations, when the UE enables the function, the UE transmits the assistance information for UL traffic as described above.

In some implementations, the gNB transmits, to the UE, a second RRC message (e.g., an RRCReconfiguration message) including a configuration disabling the function of transmission of the assistance information for UL traffic. In response, the UE disables the function of transmission of assistance information for UL traffic and, in some implementations, transmits a second RRC response message (e.g., an RRCReconfigurationComplete message) to the gNB. If the UE does not enable the function (e.g., the UE does not receive an RRC message (e.g., an RRCReconfiguration message) including a configuration enabling the function of transmission of the assistance information for UL traffic or receives an RRC message disabling the function), the UE refrains from transmitting the assistance information for UL traffic.

In some implementations, the gNB configures multiple PUSCH occasions per CG cycle. In further implementations, to address the jitter and the varying packet size as described above, the gNB cancels some PUSCH occasions via dynamic signalling (e.g., DCI). In some implementations, the gNB adjusts the size and the location (shift in time and frequency) and modifies the PRB and the time allocation of some PUSCH occasions in the CG cycle via dynamic signalling (e.g., DCI).

Further, the UE and/or gNB use an adaptive number of HARQ retransmissions (e.g., for better system capacity). In particular, in some implementations, the gNB and/or UE modem have awareness about the delay budget of PDUs and/or PDU sets. In further implementations, the gNB and/or UE modem have awareness about the priority of PDUs and/or PDU sets. In still further implementations, the gNB and/or UE also have awareness about RAN congestion. In some implementations, the gNB and/or UE modem decide to drop (e.g., discard) a PDU or a PDU set due to a limited delay budget (e.g., PDB close to expiry), and/or congestion (e.g., dropping low priority PDUs and/or PDU sets).

In further implementations, the gNB and/or UE also decide to limit the number of HARQ retransmissions to meet the delay budget and/or to limit congestion. In some implementations, in DL, the gNB signals to the UE that the current transmission will have no retransmissions. In some implementations, the UE does not send a HARQ-ACK feedback and flushes the buffer after the decoding regardless of the decoding result. The UE therefore reduces the DL retransmissions and the HARQ-ACK feedback overhead, improving the DL and UL capacity.

In some implementations, in UL, the UE indicates (e.g., when the current transmission is the first transmission) to the gNB that the current transmission will have no retransmissions. In further implementations, if the current transmission comprises a retransmission, the UE also indicates that the current transmission is the last retransmission. In some such cases, the gNB does not schedule a retransmission. In further implementations, the UE is more explicit and indicates the remaining delay budget for a specific PDU and/or PDU set and signals the information to the gNB via UCI (e.g., piggy-backed on PUSCH) or via MAC-CE.

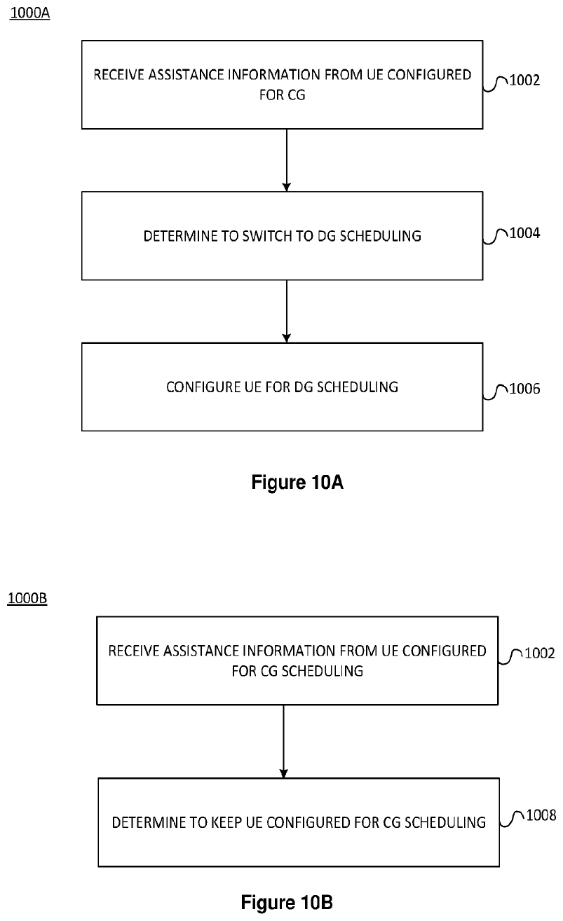

FIG. 10A illustrates an example of CG scheduling to be used for UL AR traffic jointly with DG. At 1002, the gNB receives assistance information from a UE configured with CG resources. At block 1004, the gNB determines to switch to DG scheduling. At block 1006, the gNB configures the UE for CG.

In some such implementations, a UE uses CG scheduling for UL pose/control information. For example, a UE communicating quasi-periodic uplink traffic with small or no jitter compared to downlink traffic (e.g., UL XR traffic such as UL AR video traffic) uses CG to communicate UL traffic, which benefits from the use of CG to reduce latency. In further implementations, a UE uses CG to report potential assistance information as described above. In some such implementations, the gNB determines whether to continue using CG or whether to switch to DG scheduling, as described above.

FIG. 10B illustrates another example method 1000B similar to the method 1000A. The method 1000B begins at block 1002, where the gNB receives assistance information from a UE configured for CG scheduling. At block 1008, the gNB determines to keep the UE configured for CG scheduling.

The disclosure contemplates at least the following examples.

Example 1. A method, implemented in a UE, for discarding sets of uplink packet data scheduled to be communicated with a RAN node, comprises: (i) scheduling, at the UE, transmission to the RAN node of one or more uplink data packets of an uplink data packet set; (ii) detecting at least one of: (i) a limited delay budget indicative of a remaining quantity of time until the UE flushes a buffer for transmitting the one or more uplink data packets or (ii) congestion in the RAN; and (iii) discarding the uplink data packet set responsive to the detecting.

Example 2. The method of example 1, where the detecting of the limited delay budget is based at least on detecting that a packet delay budget is close to expiration, the packet delay budget indicative of a maximum amount of time until the UE discards the one or more uplink data packets.

Example 3. The method of example 1, further comprising detecting a priority level of the uplink data packet set.

Example 4. The method of example 3, where the priority level of the uplink data packet set is indicative of a low priority data packet set.

Example 5. A method implemented in UE, for requesting modification of uplink channel occasions from a RAN node, comprises: (i) transmitting, from the UE to the RAN node, uplink control information including a first request for an adjustment of uplink resources; (ii) receiving, from the RAN node at the UE and responsive to the transmitting the uplink control information, an indication that the RAN node configures multiple uplink channel occasions; and (iii) responsive to receiving the indication, transmitting, from the UE to the RAN node, a second request to modify at least some of the multiple uplink channel occasions.

Example 6. The method of example 5, wherein the second request to modify at least some of the multiple uplink channel occasions includes a cancellation request to cancel at least some of the multiple uplink channel occasions.

Example 6. The method of example 5, where the second request to modify at least some of the multiple uplink channel occasions includes an addition request to add one or more additional uplink channel occasions.

Example 7. The method of example 5, where the second request to modify at least some of the multiple uplink channel occasions includes a modification request to modify a size of at least some of the multiple uplink channel occasions.

Example 8. The method of example 5, where the second request to modify at least some of the multiple uplink channel occasions is based on data packet information about one or more uplink data packets.

Example 9. The method of example 8, further comprising transmitting, from the UE to the RAN node, the data packet information.

Example 10. The method of example 8, where the uplink control information includes the data packet information.

Example 11. A user equipment comprising processing hardware configured to implement a method according to any one of the preceding examples.

Example 12. A method implemented in a RAN node, for modifying uplink channel occasions for a UE, comprises: (i) receiving, from the UE at the RAN node, uplink control information including a first request for adjustment of uplink resources; (ii) responsive to receiving the uplink control information, configuring multiple uplink channel occasions for the UE; (iii) receiving, from the UE at the RAN node, a second request to modify at least some of the multiple uplink channel occasions; and (iv) responsive to the second request, modifying at least some of the multiple uplink channel occasions.

Example 13. The method of claim 12, where the modifying of the at least some of the uplink channel occasions includes cancelling at least some of the uplink channel occasions.

Example 14. The method of claim 12, where the modifying of the at least some of the multiple uplink channel occasions includes adding one or more additional uplink channel occasions.

Example 15. The method of claim 12, where the modifying of the at least some of the multiple uplink channel occasions includes modifying a size of at least some of the multiple uplink channel occasions.

Example 16. The method of claim 12, further comprising receiving, from the UE at the RAN node, data packet information about one or more uplink data packets; where modifying the at least some of the uplink channel occasions is based at least on the data packet information.

Example 17. The method of claim 16, where the uplink control information includes the data packet information about the uplink data packets.

Example 18. A network node comprising processing hardware and configured to implement a method according to any one of examples 12-18.

Example 19. A transmission method implemented in a user equipment (UE), the method comprising: (i) generating an indication of a remaining delay budget for uplink (UL) data; (ii) transmitting, to a radio access network (RAN), the indication of the remaining delay budget; and (iii) transmitting the UL data to the RAN, via one or more UL resources allocated by the RAN.

Example 20. The method of example 19, further comprising transmitting an indication of a size of the uplink data.

Example 21. The method of example 20, where the indication of the size of the uplink data is transmitted together with the indication of the remaining delay budget.

Example 22. The method of any of examples 19-21, where the remaining delay budget is transmitted with a priority level of the uplink data.

Example 23. The method of any of examples 19-22, further comprising transmitting, to the RAN node, uplink assistance information.

Example 24. The method of any of examples 19-23, where the uplink assistance information includes a burst arrival time of the uplink data packet.

Example 25. The method of example 23 or 24, wherein the uplink assistance information is transmitted in a radio resource control (RRC) message.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “configuration activation command” can be replaced by “serving cell change command”, “Layer 1/Layer 2 switching command”, “lower layer switching command” or “lower layer serving cell change command” . The “fast serving cell configuration procedure”can be replaced by “fast serving cell change procedure”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a user equipment (UE), the method comprising:
generating an indication of a remaining delay budget for uplink (UL) data;
transmitting, to a radio access network (RAN), the indication of the remaining delay budget;
discarding at least some of the UL data based on a priority level of the at least some of the UL data; and
transmitting a remainder of the UL data to the RAN via one or more UL resources allocated by the RAN.

2. The method of claim 1, wherein the remaining delay budget is generated for a protocol data unit (PDU).

3. The method of claim 1, wherein the remaining delay budget is generated for a PDU set.

4. The method of claim 1, wherein the indication of the remaining delay budget is transmitted via a medium access control (MAC) control element (CE).

5. The method of claim 1, wherein the indication of the remaining delay budget is transmitted via uplink control information (UCI).

6. The method of claim 1, further comprising:
transmitting, to the RAN via a radio resource control (RRC) message, application-related assistance information.

7. The method of claim 6, wherein the application-related assistance information includes arrival time of UL traffic with which the UL data is associated.

8. The method of claim 6, wherein the application-related assistance information is included in a UEAssistanceInformation message.

9. The method of claim 1, further comprising:
transmitting, to the RAN, a request for adjustment of the one or more UL resources.

10. The method of claim 9, wherein the request for adjustment includes a request to cancel at least some of the one or more UL resources.

11. (canceled)

12. (canceled)

13. A method implemented in a base station, the method comprising:
allocating, to a user equipment (UE), resources for transmitting uplink (UL) data;
receiving, from the UE, an indication of a remaining delay budget related to the UL data;
adjusting the resources based on the indication; and
causing the UE to discard at least some of the UL data based on a priority level of the at least some of the UL data.

14. The method of claim 13, wherein the resources are configured grant (CG) resources.

15. (canceled)

16. A computing device functioning as a user equipment (UE), the computing device comprising:
processing hardware configured to:
generate an indication of a remaining delay budget for uplink (UL) data;
transmit, to a radio access network (RAN), the indication of the remaining delay budget;
discard at least some of the UL data based on a priority level of the at least some of the UL data; and
transmit a remainder of the UL data to the RAN via one or more UL resources allocated by the RAN.

17. The computing device of claim 16, wherein the remaining delay budget is generated for a protocol data unit (PDU).

18. The computing device of claim 16, wherein the remaining delay budget is generated for a PDU set.

19. The computing device of claim 16, wherein the indication of the remaining delay budget is transmitted via a medium access control (MAC) control element (CE).

20. The computing device of claim 16, wherein the indication of the remaining delay budget is transmitted via uplink control information (UCI).

21. The computing device of claim 16, wherein the processing hardware is further configured to:
transmit, to the RAN via a radio resource control (RRC) message, application-related assistance information.

22. The computing device of claim 21, wherein the application-related assistance information includes arrival time of UL traffic with which the UL data is associated.

23. The computing device of claim 16, wherein the processing hardware is further configured to:
transmit, to the RAN, a request for adjustment of the one or more UL resources.
